(19) United States
(12) Patent Application Publication
(10) Pub. No.: US 2025/0218761 A1
(43) Pub. Date: Jul. 3, 2025

(54) METHOD OF MASS SPECTROMETRY, A METHOD OF MANIPULATING IONS USING AN ION STORE, AN ION STORE, A MASS SPECTROMETER AND COMPUTER SOFTWARE

(71) Applicant: Thermo Fisher Scientific (Bremen) GmbH, Bremen (DE)

(72) Inventors: Hamish Stewart, Bremen (DE); Alexander A. Makarov, Bremen (DE)

(73) Assignee: Thermo Fisher Scientific (Bremen) GmbH, Bremen (DE)

(21) Appl. No.: 19/007,380

(22) Filed: Dec. 31, 2024

(30) Foreign Application Priority Data
Jan. 3, 2024 (GB) 2400071.3

(51) Int. Cl. H01J 49/42; H01J 49/00; H01J 49/06

(52) U.S. Cl. CPC H01J 49/4295; H01J 49/0031; H01J 49/061; H01J 49/4215; H01J 49/429

(57) ABSTRACT

Methods of mass spectrometry comprise, for each of a plurality of sub-ranges selected from an overall m/z range, injecting a sample of precursor ions into a first ion store via an entrance aperture region, the precursor ions having m/z values within the sub-range; retaining a first portion of the sample of precursor ions within the first ion store; and ejecting a second portion of the sample of precursor ions from the first ion store via an outlet region.

### CROSS REFERENCE TO RELATED APPLICATION

This application claims priority from GB2400071.3, filed Jan. 3, 3024, which is incorporated herein by reference.

### FIELD

The field of this this invention is liquid chromatography mass spectrometry (LC-MS). In particular, this invention relates to tandem mass spectrometry where precursor ions and fragment ions are analysed. More particularly, the invention relates to improving the dynamic range of an MS1 scan in tandem mass spectrometry. The invention is relevant particularly, although not exclusively, to advanced hybrid mass spectrometers with multiple analysers.

### BACKGROUND

Standard tandem liquid chromatography mass spectrometry (LC-MS) methods include performing “MS1” scans, where ions having a wide range of m/z are analysed by a mass analyser to produce an MS1 spectrum (containing information about precursor ions). Methods of operating a LC-MS further involve the isolation and fragmentation of ions from eluted analyte species in order to perform “MS2” scans, where a narrow m/z range of ions is isolated (e.g., using a quadrupole mass filter), those ions are fragmented, and the fragment ions are mass analysed to produce an MS2 spectrum, containing structural and quantitative information about fragment ions.

In LC-MS methods, multiple MS2 scans are typically performed during a chromatographic separation, where the m/z isolation range is different for each MS2 scan. The MS2 (or “MS/MS”) spectra are supported by the MS1 (or “MS” or “Full-MS”) survey scans, which provide high quality peak information such as accurate mass data and precursor intensity of a wide range of unfragmented precursor ions.

For Data Independent Acquisition (DIA) methods, the MS1 scan is optional and may be skipped to allow time to generate additional MS2 spectra. A list of m/z targets for each of the plural MS2 scans can be a stepwise increasing/decreasing list of m/z across an m/z range of interest. An example of this is described in EP 3,410,463, which is herein incorporated by reference. The resulting precursor information can be used for quantitation, while fragment information can be used for identification. In Data Dependent Acquisition (DDA), the MS1 step is required to generate a list of precursor targets for MS2 analysis. The list of m/z targets for each of the plural MS2 scans corresponds to a list of precursors ions identified in an MS1 scan.

To mass analyse ions, ions (fragment ions or precursor ions) are commonly first accumulated in an ion trap, and then the accumulated ions are ejected as a packet into the mass analyser for mass analysis. Accumulation improves the sensitivity of the instrument but requires careful (so-called “Automatic Gain Control”, AGC) over the fill time of ions into the ion trap to avoid detrimental space charge effects.

One problem with existing methods is that the dynamic range of the MS1 spectrum is limited. Digested peptide concentration varies by more than 10 orders of magnitude depending on the sample, but the dynamic range of a single shot spectrum in, for example, an electrostatic orbital trap mass analyser (such as an Orbitrap™ FT mass analyser made by Thermo Fisher Scientific™) may be limited to around 4 orders of magnitude. Furthermore, the number of ions that may be injected into the orbital trap mass analyser is limited by the capacity of the accumulating C-Trap to approximately 10⁵. Consequently, low intensity peptide precursor signals may be overwhelmed. For DDA experiments, these issues are significant and could result in precursor targets being missed. For DIA experiments, a lack of good precursor data hinders identification and quantitation.

One method to improve the dynamic range of the MSI spectrum is the “Boxcar” method (as described in Meier et al, Nature Methods, 2018, 15, 440-448), and the high dynamic range (HDR) method described in UK Patent Application Number 2211790.7, which is herein incorporated by reference. In these approaches, the wide mass range of the analysis is subdivided into a number of narrower isolation windows. For each isolation window, a separate injection is made into the C-Trap, with a differing fill time dependent on the ion current. By this method heavily populated m/z regions are attenuated and sparsely populated m/z regions are amplified. Thus, detection sensitivity for relatively weak peaks is improved and the effective dynamic range of the scan is increased. However, use of these methods significantly increases the time required to accumulate ions, especially when a substantial number of isolation windows are required. Because of the long fill times for low-level windows, and the time required to switch the quadrupole and ion source voltages, HDR scanning may require a significant amount of additional time and impact the rate at which MS2 scans may be made. Therefore, these methods may decrease the time available for MS2 scans in fast LC-MS methods, which are limited by the time taken for the sample to elute from the chromatography column.

Multiple-window HDR methods also suffer from the drawback of discarding a considerable number of ions due to quadrupole isolation. Loss of ions may be addressed via a pre-accumulation process. For example, trapped ion mobility devices may be used to pre-accumulate ions prior to a quadrupole and release them in a mass/mobility dependent manner synchronized to the mass filter, greatly reducing ion losses (as described in Meier et al, Molecular & Cellular Proteomics, 2018, 17, 2524-2545).

Differential mobility filtration may be used to improve proteomics performance by removing analytically less useful singly charged ions from the accumulated population (as described in Hebert et al, Anal. Chem., 2018, 90, 9529-9537). This may be advantageous in low sample or single cell experiments, where the analyte signal is small in comparison to the singly charged solvent background signal.

In DIA experiments, MS2 spectra may retain a proportion of unfragmented precursor ions (in quantities that are insufficient to be analytically useful). Some instruments offer an optional feature called “Stepped Collision Energy,” which is described in U.S. Pat. No. 9,536,717. This feature provides multiple separate injections into a collision cell (also referred to as a “fragmentation chamber”) at a range of collision energies, the summed population of ions are then transferred to the C-Trap/Fourier transform mass analyser and analysed together. This variation in energies improves the probability that one of the energies used is optimal for fragmenting the precursor ion. However, this approach also uses many collision energies that are not optimal for fragmenting the precursor ion, with the associated cost of ion beam time. The actual action of changing collision energy and making a second or third injection into a collision cell may not be overly time-intensive, perhaps an additional 1-3 ms overhead on a >40 ms scan cycle, in some cases.

U.S. Pat. No. 8,686,350 describes a method in which different types of ions can be accumulated in an ion trap before being ejected into a mass analyser. In one example, a combination of two types of ion with the same narrow mass range are injected into the ion trap, one fragmented and one left as intact precursor. This allows greater confidence that precursor ions may be detected and accurately mass measured. However, quantitation may suffer from the proportion of unfragmented precursor left over from the MS2 injection.

### SUMMARY

A method of mass spectrometry is provided. The method comprises the following steps for each of a plurality of sub-ranges selected from an overall m/z range:
injecting a sample of precursor ions into a first ion store via an entrance aperture region, the precursor ions having m/z values within the sub-range;
retaining a first portion of the sample of precursor ions within the first ion store, wherein the first portion comprises ions having m/z values within the sub-range; and
ejecting a second portion of the sample of precursor ions from the first ion store via an exit region, wherein the second portion comprises ions having m/z values within the sub-range.

In option a), the method further comprises analysing a sample of fragmented precursor ions in a first mass analyser, wherein the sample of fragmented precursor ions are formed from fragmentation of the second portion of precursor ions.

In option b), the method further comprises accumulating in a second ion store a sample of fragmented precursor ions to be analysed in a second ion store for analysis in a first mass analyser, wherein the sample of fragmented precursor ions are formed from fragmentation of the second portion of precursor ions.

The proposed method facilitates splitting an ion beam proportionally, based on the energy distribution of the ion beam. The ion beam may be split using a potential barrier in the first ion store. The split ion beam may be used for creation of parallel accumulation regions for simultaneous accumulation of precursor ions (SIM injections) for a HDR MS1 scan, alongside a series of MS2 scans.

The sample of precursor ions may be split based on the energy of each ion. Therefore, each of the first and second portions may comprise ions from the same m/z sub-range. This is in contrast to some prior art methods, which split ion samples into portions based on the m/z values of the ions, so that the portions each comprise ions from different m/z sub-ranges.

The methods described here may be used to build up a high quality HDR scan (or equivalent precursor data from a plurality of MS1 scans, where each scan spans a plurality of sub-ranges).

The proposed methods are suitable for quantitation of a wide dynamic range of analyte ions. Performing separate MS1 and MS2 scans normally would involve prolonged delays to switch the ion source and quadrupole to scan through the mass range, independent of the DIA cycle for obtaining fragment data. The number of ions to be processed for an HDR scan is high and therefore always costs a substantial proportion of ion beamtime.

The fragmented precursor ions in the sample of fragmented precursor ions may be formed from fragmentation of precursor ions having m/z values within the sub-range. More specifically, the sample of fragmented precursor ions may consist of fragmented precursor ions formed from fragmentation of precursor ions having m/z values within the sub-range.

The second portion of the sample of precursor ions may be the remaining portion of the packet of ions after the first portion of the packet of ions has been split off. In other words, the sample of precursor ions may consist of the first portion and the second portion.

The sample of precursor ions may consist of precursor ions having m/z values within the sub-range.

The inlet region may comprise an inlet aperture.

The outlet region may comprise an outlet aperture.

Each of the plurality of sub-ranges may have the same width.

The width of each sub-range may be 20 Thomson or less.

Preferably, the injected ions are quite narrowly mass filtered. In some examples, the width of each sub-range may be 5 Thomson or less.

The plurality of sub-ranges may be contiguous.

A DC potential barrier may be provided at the outlet region.

In some examples, a second DC potential barrier may be provided at the inlet region.

The method may further comprise, for each sub-range, determining a charge state of the sample of precursor ions and adjusting the DC potential barrier, based on the charge state of the sample of precursor ions. The method may further comprise, for each sub-range, adjusting the DC potential barrier, based on the m/z sub-range. In other words, the level of the DC barrier may be tailored based on the m/z values of the injected precursor ions.

The method may further comprise, for each sub-range, adjusting the DC potential barrier to compensate for space charge conditions.

The first ion store may comprise one or more intermediate potential barriers. The first portion of the sample of precursor ions may be retained under the one or more intermediate potential barriers. The one or more intermediate potential barriers may be relatively small compared to the DC potential barrier at the outlet region.

By providing intermediate potential barriers for retaining ions, the retained ions may be more evenly distributed throughout the first ion store.

The one or more intermediate potential barriers may be provided by one or more auxiliary trapping electrodes.

The method may further comprise, for each sub-range, adjusting an ion energy of the sample of precursor ions to compensate for space charge conditions.

Space charge conditions occur in the ion store as the quantity of ions accumulated/retained increases. This may raise the local potential, redistribute incident ion energy, and/or cause already trapped ions to be pushed out axially and/or radially. Therefore, parameters of operation (such as the level of the DC potential barrier and/or the ion injection energy) may be adjusted to compensate for these effects and control the proportion of ions that are retained in the first ion store.

The levels of the intermediate potential barriers may be adjusted to redistribute the retained ions within the store and influence space charge conditions within the ion store.

The method may further comprise, for each sub-range, adjusting an ion energy of the sample of precursor ions, based on the m/z sub-range. In other words, the ion injection energy may be tailored based on the m/z values of the injected precursor ions.

Retaining the first portion of the sample of precursor ions within the first ion store may comprise retaining the first portion of the sample of precursor ions away from a principal axis of the first ion store, so that the sample of precursor ions for the immediately subsequent sub-range are not blocked.

The first ion store may comprise a weak potential saddle, so that the first portion of the sample of precursor ions are stored away from a principal axis of the first ion store.

The first ion store may have a length that is sufficient that a majority the first portion of the sample of precursor ions are retained in the first ion store away from the outlet region.

The samples of precursor ions for each of the plurality of sub-ranges may be combined together in the first ion store, so that the first ion store contains precursor ions having m/z values from the overall m/z range.

The samples of precursor ions for each of the plurality of sub-ranges may be combined together in the first ion store, so that the first ion store contains precursor ions having m/z values from the overall m/z range. In other words, there may be ions from each sub-range in the first ion store.

The method may further comprise analysing the combined samples of precursor ions having m/z values from the overall m/z range in the first mass analyser or a second mass analyser. In other words, the retained portions of the plurality of SIM injections may be combined together in the first ion store and analysed together in a mass analyser. Whilst the precursor accumulation step is performed for each sub-range, the step of analysing the combined samples of precursor ions may be performed once for the overall m/z range.

In a first example, the method further comprises ejecting precursor ions from the first ion store into a second mass analyser. In other words, there may be two mass analysers in tandem.

The precursor ions ejected from the first ion store into the second mass analyser may comprise the combined first portions of precursor ions from a plurality of sub-ranges. In some examples, the precursor ions ejected from the first ion store into the second mass analyser may comprise the combined first portions of retained precursor ions for each of the plurality of sub ranges.

The method may further comprise analysing the precursor ions in the second mass analyser.

The first mass analyser (for analysing the fragment ions) may be a time-of-flight mass analyser.

The second mass analyser (for analysing the precursor ions) may be a Fourier transform mass analyser.

In a second example, the method may further comprise transferring precursor ions retained in the first ion store to the first mass analyser (in option a) or the second ion store (in option b). In the second example, the combined precursor ions retained in the first ion store (the combined first portions of retained precursor ions) are sent to the first mass analyser. Therefore, a second mass analyser may not be required.

The first mass analyser (for analysing the fragment ions and the precursor ions) may be a time-of-flight mass analyser.

Where the sample of fragmented precursor ions are accumulated in the second ion store and the precursor ions retained in the first ion store are transferred to the second ion store (option b), the method may further comprise ejecting the precursor ions from the second ion store into the first mass analyser.

The precursor ions transferred from the first ion store (to either the first mass analyser or the second ion store) may comprise the first portions of the samples of precursor ions for each of the plurality of sub ranges.

The transferred precursor ions may comprise precursor ions having m/z values from the overall m/z range. In other words, the transferred precursor ions may comprise the combined samples from each sub-range.

Where the sample of fragmented precursor ions is accumulated in the second ion store (option b), the method may further comprise (for each sub range) ejecting the sample of fragmented precursor ions from the second ion store into the first mass analyser.

The sample of fragmented precursor ions may be ejected from the second ion store after each accumulation (before accumulation of fragment ions formed from fragmentation of precursor ions from the next sub-range).

The sample of fragmented precursor ions may be ejected from the second ion store before the precursor ions are transferred to the second ion store.

The precursor ions may be transferred from the first ion store to the second ion store after the samples of fragmented precursor ions for each of the plurality of sub ranges have been ejected from the second ion store into the first mass analyser.

The method may further comprise, for each of the plurality of sub-ranges, analysing the first portion of the sample of the precursor ions in the first mass analyser or a second mass analyser. In this alternative, the precursor ions for each sub-range are analysed separately in a SIM scan, rather than accumulating all the SIM injections together and analysing the precursor ions from the overall m/z range in one scan. The SIM scans may be interleaved with the fragment scans, which may advantageously mean that reconfiguration of the ion filter is not required between the SIM scan and fragment scan for each sub-range. The method may further comprise obtaining scan data relating to the precursor ions for each sub-range. The method may further comprise combining the scan data relating to the precursor ions for each sub-range to form a high-definition scan for the overall m/z range. In other words, the SIM scan data is stitched together to provide a high-resolution MS scan. A pre-scan may not be needed in this case (since the sub-ranges are contiguous and cover the overall m/z range).

In another example, the HDR MS scan could be split into a plurality of scans, each of the plurality of scans relating to precursor ions from a plurality of contiguous sub-ranges. In this alternative, each scan comprises simultaneous analysis of precursor ions skimmed off from multiple SIM injections. The method may further comprise combining the scan data from each of the plurality of scans to form a high-definition scan for the overall m/z range. A pre-scan may not be needed in this case because a) the sub-ranges are contiguous and cover the overall m/z range and b) each of the sub-ranges is analysed in a corresponding one of the plurality of scans.

In some examples, the first ion store may be configured to operate under pure molecular flow conditions. Pure molecular flow conditions (also called free molecular flow or Knudsen diffusion) are observed when the Knudsen number, Kn, is greater than 20 or more preferably Kn>10.

The method may further comprise fragmenting the second portion of the sample of precursor ions to produce the sample of fragmented precursor ions.

Where the sample of fragmented precursor ions is accumulated in the second ion store (option b), the ions may be fragmented in the second ion store.

In other words, precursor ions may be directed to the second ion store and then the ions may be fragmented once they have been accumulated in the second ion store.

Alternatively, the ions may be fragmented using a multipole collision cell (e.g., an IRM collision cell).

The multipole collision cell may be downstream of the first ion store so that the second portion of the sample of precursor ions are directed to the multipole collision cell, which then transfers fragmented ions to the first mass analyser (in option a) or second ion store (in option b). In other words, in option a), the multipole collision cell may be between the first ion store and the first mass analyser or, in option b), the multipole collision cell may be between the first ion store and the second ion store.

In option b), the fragmented ions may be accumulated in the second ion store, and then ejected from the second ion store into the first mass analyser.

The method may further comprise, for each of the plurality of sub-ranges, configuring an ion filter to transmit precursor ions having m/z values within the sub-range. The sample of precursor ions may be received from the configured ion filter. The sample of fragmented precursor ions may be formed from fragmentation of precursor ions received from the configured ion filter (the second portion of the sample of precursor ions).

In other words, the ion filter may not be reconfigured between filling the first ion store and the second ion store.

The sample of fragmented precursor ions may be formed from fragmentation of the second portion of the sample of precursor ions ejected from the first ion store.

Configuring the ion filter may comprise setting a transmission window of the ion filter. The transmission window may be adjusted between each of the plurality of sub-ranges. For each sub-range, the transmission window for the step of injecting the sample of precursor ions may be the same as the transmission window for the step of analysing the sample of fragmented precursor ions (in option a) or accumulating the sample of fragmented precursor ions in the second ion store (in option b).

A front-end accumulation device, such as an ion mobility separator such as a

Trapped Ion Mobility Separator (as incorporated into the Bruker TIMS-ToF series of mass spectrometers), may be used (and would be advantageous to the methods described herein). Such a device may release ions in an m/z range synchronised to the quadrupole isolation window. As a result, ion transmission is greatly boosted. As a further result, the required injection time may be reduced (due to a brighter isolated ion beam). This reduction in injection time may be used to offset the additional time overhead of the SIM injections.

The method may further comprise configuring an ion mobility separator to transfer precursor ions having m/z values within the sub-range to the ion filter.

The method may further comprise controlling the ion mobility separator so that the precursor ions transferred to the ion filter correspond with a transmission window of the ion filter, for each of the plurality of sub-ranges in the overall m/z range.

Injecting the sample of precursor ions may comprise controlling a fill time for the precursor ions, based on a relative abundance of precursor ion species in the corresponding sub-range.

Where the sample of fragmented precursor ions is accumulated in the second ion store (option b), the method may further comprise, for each of the plurality of sub-ranges, ejecting the sample of fragmented precursor ions from the second ion store into the first mass analyser and analysing the sample of fragmented precursor ions in the first mass analyser.

The first mass analyser may be a time-of-flight mass analyser.

The first mass analyser may be a multi-reflection time-of-flight, MR-ToF, mass analyser.

The first ion store may be a curved linear trap (e.g., a c-trap).

Where the sample of fragmented precursor ions is accumulated in the second ion store (option b), the second ion store may be a linear trap (e.g., a DP-R Trap).

The method may further comprise ionising the sample to produce the precursor ions.

The sample of fragmented precursor ions may be formed from fragmentation of precursor ions having m/z values within the sub-range at a plurality of different collision energies.

The method may further comprise:
configuring an ion filter to transmit precursor ions having m/z values from the overall m/z range;
transferring an initial sample of precursor ions having m/z values from the overall m/z range to the first mass analyser or a second mass analyser;
analysing the initial sample of precursor ions; and
obtaining scan data for the overall m/z range from analysis of the initial sample of precursor ions.

In other words, the method may comprise a pre-scan of the overall m/z range, prior to analysis of ions from the plurality of sub-ranges (e.g., an AGC pre-scan). Optionally, the method may comprise accumulating (in a single fill and in either the first ion store or the second ion store) the initial sample of precursor ions having m/z values from the overall m/z range. Alternatively, the initial sample may be directed to the first mass analyser or the second mass analyser. Analysing the initial sample of precursor ions having m/z values from the overall m/z range may comprise obtaining scan data for the overall m/z range (which may be low-resolution, full-MS scan data, rather than SIM scan data). The method may further comprise, for each sub-range, adjusting an injection time of the sample of precursor ions based on the scan data obtained from analysis of the initial sample of precursor ions (having m/z values for the overall m/z range).

More specifically, the injection time for each sub-range may be based on relative abundances of precursor ion species in each sub-range, to improve the dynamic range of the MS1 produced by analysing the combined retained first portions of precursor ions from the SIM injections.

The method may further comprise determining the plurality of sub-ranges from the overall m/z range, based on the scan data obtained from analysis of the initial sample of precursor ions (having m/z values from the overall m/z range). This may be referred to as a Data Dependent Acquisition, DDA, method.

The method may be performed within a time period based on a width of a chromatographic peak of the sample as it elutes from a chromatography system.

A method of manipulating ions using an ion store is also provided. The ion store comprises: an inlet region; an outlet region; a trapping volume between the inlet region and the outlet region. The method comprises:
injecting a packet of ions via the inlet region, wherein the packet of ions comprises ions having m/z values within a sub-range selected from an overall m/z range;
applying a DC potential barrier at the inlet region and the outlet region;
retaining a first portion of the packet of ions within the trapping volume, wherein the first portion comprises ions having m/z values within the sub-range;
ejecting a second portion of the packet of ions via the outlet region, wherein the second portion comprises ions having m/z values within the sub-range.

The proposed method may be used to split an ion beam within a known ion store, such as a C-Trap. Operation of the proposed method may be achieved via partial transmission of the ion beam (or packet of ions) across the exit lens. The proposed method provides a beam splitter based upon collisional cooling, which is also extendable to other ion guide structures.

Many other uses of the split ion beam may also be possible. For example, splitting off ions for any other purpose such as alternative fragmentation. Many other uses of the beam splitting method may also be possible. For example, the method may be used for splitting off ions for any other purpose, such as alternative fragmentation. The proposed method therefore may have applications beyond the examples provided (e.g., preparing ions for an HDR scan). For example, the retained ions may be sent to another detector for quantitation (e.g., a secondary electron multiplier with single-ion detection, as taught by U.S. Pat. No. 9,812,307).

The DC potential applied at the outlet region may create a potential barrier that causes the first portion of the packet of ions to be retained in the ion store.

The trapping volume may be between the inlet and outlet regions.

The inlet region may comprise an inlet aperture.

The outlet region may comprise an outlet aperture.

The DC potential barrier applied at the outlet region may be greater than a DC potential in the trapping volume.

The DC potential barrier applied at the inlet region may be greater than a DC potential in the trapping volume.

A m/z range of the packet of ions may be 20 Thomson (Th) or less. Preferably, the injected ions are quite narrowly mass filtered. In some examples, the m/z range of the packet of ions may be 5 Thomson or less.

The method may further comprise determining a charge state of the packet of ions and adjusting the DC potential barrier at the outlet region, based on the determined charge state of the packet of ions.

The method may further comprise, adjusting an ion energy of the packet of ions, based on a m/z range of the packet of ions. In other words, the level of the DC barrier may be tailored based on the m/z values of the injected ions.

The method may further comprise, adjusting a DC potential barrier at the outlet aperture, based on a m/z range of the packet of ions.

The method may further comprise adjusting an ion energy of the packet of ions and/or adjusting a DC potential barrier at the outlet aperture to compensate for space charge conditions.

Retaining the first portion of the packet of ions within the ion store may comprise retaining the first portion of the packet of ions away from a principal axis of the ion store.

The ion store may comprise a weak potential saddle, so that the first portion of the packet of ions are stored away from a principal axis of the ion store.

The ion store may have a length sufficient that a majority the first portion of the packet of ions are retained in the ion store away from the outlet region.

The ion store may comprise one or more intermediate potential barriers (between the inlet region and the outlet region). The first portion of the packet of ions may be retained under the one or more intermediate potential barriers. The one or more intermediate potential barriers may be relatively small compared to the DC potential barrier at the outlet region (and/or relatively small compared to the DC potential barrier at the inlet region).

The one or more intermediate potential barriers may be provided by one or more auxiliary trapping electrodes.

A mass spectrometer configured to perform a method described above is also provided.

An ion store configured to perform a method described above is also provided.

Computer software comprising instructions that, when executed by the processor of a computer, cause the computer to perform a method described above is also provided.

### BRIEF DESCRIPTION OF THE DRAWINGS

The invention may be put into practice in a number of ways and specific embodiments will now be described by way of example only and with reference to the following Figures.

FIG. 1 shows a schematic diagram of a mass spectrometer suitable for carrying out methods in accordance with embodiments of the invention.

FIG. 2 illustrates a beam clipping method within an ion store, based upon discrimination by ion energy.

FIG. 3A illustrates signal intensity in a Fourier transform mass analyser performing full-MS scans on ions retained across a plurality of sub-ranges against time, as a potential barrier at the outlet aperture of a C-Trap (the “exit lens potential”) is increased over time.

FIG. 3B illustrates signal intensity in a time-of-flight mass analyser performing MS2 fragment scans for each of the plurality of sub-ranges against time, as a potential barrier at the outlet aperture of a C-Trap (the “exit lens potential”) is increased over time.

FIG. 4 illustrates MS1 spectra produced by a Fourier transform mass analyser during a DIA run for three different values of the potential barrier at the outlet region of the ion store.

FIG. 5 illustrates a DIA method for parallel accumulation of SIM injections in a curved linear ion store, building to a single HDR scan using a Fourier transform mass analyser, interleaved between a series of MS2 scans in a time-of-flight mass analyser.

### DETAILED DESCRIPTION

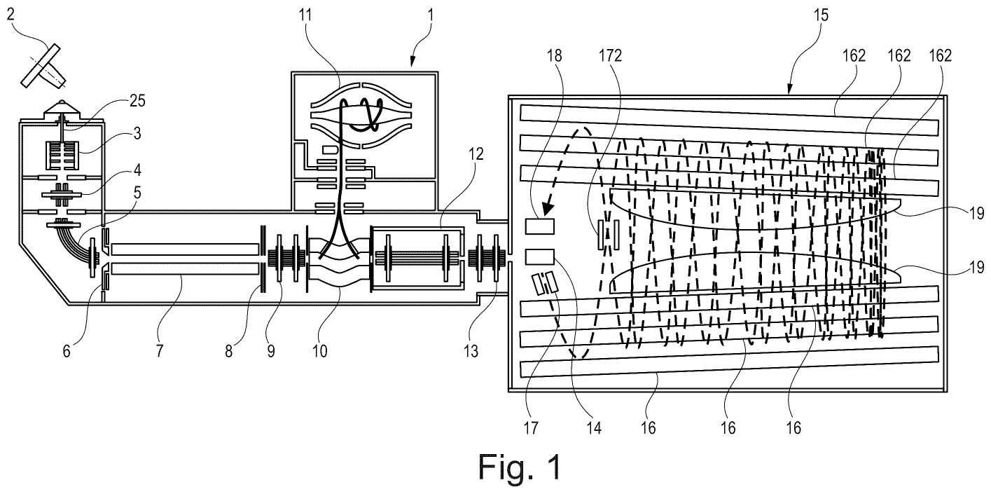

FIG. 1 shows a schematic arrangement of a mass spectrometer 1 suitable for carrying out methods in accordance with embodiments of the present invention. The mass spectrometer 1 may be a Hybrid Fourier transform/multi-reflection time-of-flight mass spectrometer (MR-ToF) described in U.S. Pat. No. 10,699,888, which is incorporated by reference. The details of the mass analyser are described in U.S. Pat. No. 9,136,101, which is herein incorporated by reference. In FIG. 1, a sample to be analysed is supplied (for example from an autosampler) to a chromatographic apparatus such as a liquid chromatography (LC) column (not shown in FIG. 1). One such example of an LC column is the Thermo Fisher Scientific, Inc ProSwift monolithic column which offers high performance liquid chromatography (HPLC) through the forcing of the sample carried in a mobile phase under high pressure through a stationary phase of irregularly or spherically shaped particles constituting the stationary phase. In the HPLC column, sample molecules elute at different rates according to their degree of interaction with the stationary phase.

A chromatograph may be produced by measuring over time the quantity of sample molecules that elute from the HPLC column using a detector (for example a mass spectrometer). Sample molecules which elute from the HPLC column will be detected as a peak above a baseline measurement on the chromatograph. Where different sample molecules have different elution rates, a plurality of peaks on the chromatograph may be detected. Preferably, individual sample peaks are separated in time from other peaks in the chromatogram such that different sample molecules do not interfere with each other.

On a chromatograph, a presence of a chromatographic peak corresponds to a time period over which the sample molecules are present at the detector. As such, a width of a chromatographic peak is equivalent to a time period over which the sample molecules are present at a detector. Preferably, a chromatographic peak has a Gaussian shaped profile, or can be assumed to have a Gaussian shaped profile. Accordingly, a width of the chromatographic peak can be determined based on a number of standard deviations calculated from the peak. For example, a peak width may be calculated based on 4 standard deviations of a chromatographic peak. Alternatively, a peak width may be calculated based on the width at half the maximum height of the peak. Other methods for determining the peak width known in the art may also be suitable.

The sample molecules thus separated via liquid chromatography are then ionized using an electrospray ionization source (ESI source) 2 which is at atmospheric pressure. Sample ions then enter a vacuum chamber of the mass spectrometer 1 and are directed by a capillary 25 into an RF-only S lens 3 (also called an ion funnel). The ions are focused by the S lens 3 into an injection flatapole 4 (also called a quadrupole pre-filter) which injects the ions into a bent flatapole 5 with an axial field. The bent flatapole 5 guides (charged) ions along a curved path through it whilst unwanted neutral molecules such as entrained solvent molecules are not guided along the curved path and are lost. The curved path may be a 90-degree bend or an s-shaped wiggle, for example.

A TK lens 6 located at the distal end of the bent flatapole 5. Ions pass from the bent flatapole 5 into a downstream mass selector in the form of a quadrupole mass filter 7. The TK lens acts as a fringe field corrector for the quadrupole mass filter 7. The quadrupole mass filter 7 is typically but not necessarily segmented and serves as a band pass filter, allowing passage of a selected mass number or limited mass range whilst excluding ions of other mass to charge ratios (m/z). The mass filter can also be operated in an RF-only mode in which it is not mass selective, i.e. it transmits substantially all m/z ions. For example, the quadrupole mass filter 7 may be controlled by the controller to select a range of mass to charge ratios to pass of the precursor ions which are allowed to pass, whilst the other ions in the precursor ion stream are filtered (attenuated).

Alternatively, the S lens 3 may be operated as an ion gate and the ion gate (TK lens) 6 may be a static lens.

Although a quadrupole mass filter is shown in FIG. 1, the skilled person will appreciate that other types of mass selection devices may also be suitable for selecting precursor ions within the mass range of interest. For example, an ion separator as described in US 2015/0287585, an ion trap as described in WO 2013/076307, an ion mobility separator as described in US 2012/0256083, an ion gate mass selection device as described in WO 2012/175517, or a charged particle trap as described in U.S. Pat. No. 7,999,223, which is herein incorporated by reference. The skilled person will appreciate that other methods selecting precursor ions according to ion mobility, differential mobility and/or transverse modulation may also be suitable.

The isolation of a plurality of ions of different masses or mass ranges may also be performed using the method known as synchronous precursor scanning (SPS) in an ion trap. Furthermore, in some embodiments, more than one ion selection or mass selection device may be provided. For example, a further mass selection device may be provided downstream of the fragmentation chamber 12. In this way, MS³ or MSⁿ scans can be performed if desired (typically using the ToF mass analyser for mass analysis).

Ions then pass through a quadrupole exit lens/split lens arrangement 8 that acts as an ion gate to control the passage of ions into a first transfer multipole 9, optionally via a charge detector (not illustrated). The first transfer multipole 9 guides the mass filtered ions from the quadrupole mass filter 7 into a curved linear ion trap (C-trap) 10. The C-trap (first ion store) 10 has longitudinally extending, curved electrodes which are supplied with RF voltages and end caps that to which DC voltages are supplied. The result is a potential well that extends along the curved longitudinal axis of the C-trap 10. In a first mode of operation, the DC end cap voltages are set on the C-trap so that ions arriving from the first transfer multipole 9 are captured in the potential well of the C-trap 10, where they are cooled. The injection time (IT) of the ions into the C-trap determines the number of ions (ion population) that is subsequently ejected from the C-trap into the mass analyser.

Cooled ions reside in a cloud towards the bottom of the potential well and are then ejected orthogonally from the C-trap towards the second mass analyser 11. As shown in FIG. 1, the second mass analyser is a Fourier transform mass analyser, such as an orbital trapping mass analyser 11, for example the Orbitrap™ mass analyser sold by Thermo Fisher Scientific, Inc. The Fourier transform mass analyser 11 has an off centre injection aperture and the ions are injected into the orbital trapping mass analyser 11 as coherent packets, through the off centre injection aperture. Ions are then trapped within the orbital trapping mass analyser by a hyperlogarithmic electric field, and undergo back and forth motion in a longitudinal direction whilst orbiting around the inner electrode.

The axial (z) component of the movement of the ion packets in the orbital trapping mass analyser is (more or less) defined as simple harmonic motion, with the angular frequency in the z direction being related to the square root of the mass to charge ratio of a given ion species. Thus, over time, ions separate in accordance with their mass to charge ratio.

Ions in the orbital trapping mass analyser are detected by use of an image current detector (not shown) which produces a “transient” in the time domain containing information on all of the ion species as they pass the image current detector. The transient is then subjected to a Fast Fourier Transform (FFT) resulting in a series of peaks in the frequency domain. From these peaks, a mass spectrum, representing abundance/ion intensity versus m/z, can be produced.

In the configuration described above, the sample ions (more specifically, a mass range segment of the sample ions within a mass range of interest, selected by the quadrupole mass filter 7) are analysed by the orbital trapping mass analyser 11 without fragmentation. The resulting mass spectrum is denoted MS1.

Although an orbital trapping mass analyser 11 is shown in FIG. 1, other mass analysers including other Fourier Transform mass analysers may be employed instead. For example a Fourier Transform Ion Cyclotron Resonance (FTICR) mass analyser may be utilised as mass analyser for the MS1 scans. Mass analysers, such as the orbital trapping mass analyser and Ion Cyclotron Resonance mass analyser, may also be used in the invention even where other types of signal processing than Fourier transformation are used to obtain mass spectral information from the transient signal (see for example WO 2013/171313, Thermo Fisher Scientific).

In a second mode of operation of the C-trap 10, ions passing through the quadrupole exit lens/split lens arrangement 8 and first transfer multipole 9 into the C-trap 10 may also continue their path through the C-trap and into the fragmentation chamber 12, which may be an “Ion Routing Multipole” (IRM) collision cell. As such, the C-trap effectively operates as an ion guide in the second mode of operation. Alternatively, cooled ions in the C-trap 10 may be ejected from the C-trap in an axial direction into the fragmentation chamber 12. The fragmentation chamber 12 is, in the mass spectrometer 1 of FIG. 1, a high energy collisional dissociation (HCD) device to which a collision gas is supplied. Precursor ions arriving into the fragmentation chamber 12 collide with collision gas molecules resulting in fragmentation of the precursor ions into fragment ions.

Although an HCD fragmentation chamber 12 is shown in FIG. 1, other fragmentation devices may be employed instead, employing such methods as collision induced dissociation (CID), electron capture dissociation (ECD), electron transfer dissociation (ETD), photodissociation, and so forth. Moreover, ion fragmentation may be performed in a high-pressure region of the extraction trap 14.

Fragmented ions may be ejected from the fragmentation chamber 12 at the opposing axial end to the C-trap 10. The ejected fragmented ions pass into a second transfer multipole 13. The second transfer multipole 13 guides the fragmented ions from the fragmentation chamber 12 into an extraction trap (second ion trap) 14. The extraction trap 14 is a radio frequency voltage-controlled trap containing a buffer gas. For example, a suitable buffer gas is argon at a pressure in the range 5×10⁻⁴ mBar to 1×10⁻² mBar. The extraction trap has the ability to quickly switch off the applied RF voltage and apply a DC voltage to extract the trapped ions. A suitable flat plate extraction trap, also referred to as a rectilinear ion trap, is further described in U.S. Pat. No. 9,548,195, which is herein incorporated by reference. Alternatively, a C-trap may also be suitable for use as a second ion trap.

The extraction trap 14 is provided to form an ion packet of fragmented ions, prior to injection into the time-of-flight mass analyser 15. The extraction trap 14 accumulates fragmented ions prior to injection of the fragmented ions into the time-of-flight mass analyser 15.

Although an extraction trap (ion trap) is shown in the embodiment of FIG. 1, the skilled person will appreciate that other methods of forming an ion packet of fragmented ions will be equally suitable for the present invention. For example, relatively slow transfer of ions through a multipole can be used to affect bunching of ions, which can subsequently be ejected as a single packet to the ToF mass analyser. Alternatively orthogonal displacement of ions may be used to form a packet. Further details of these alternatives are found in US 2003/0001088 which describes a travelling wave ion bunching method, which is herein incorporated by reference.

In FIG. 1, the time-of-flight mass analyser 15 shown is a multiple reflection time-of-flight mass analyser (MR-ToF) 15. The MR-ToF 15 is constructed around two opposing ion mirrors 16, 162, elongated in a drift direction. The mirrors are opposed in a direction that is orthogonal to the drift direction. The extraction trap 14 injects ions into the first mirror 16 and the ions then oscillate between the two mirrors 16, 162. The angle of ejection of ions from the extraction trap 14 and additional deflectors 17, 172 allow control of the energy of the ions in the drift direction, such that ions are directed down the length of the mirrors 16, 162 as they oscillate, producing a zig-zag trajectory. The mirrors 16, 162 themselves are tilted relative to one another, producing a potential gradient that retards the ions' drift velocity and causes them to be reflected back in the drift dimension and focused onto a detector 18. The tilting of the opposing mirrors would normally have the negative side-effect of changing the time period of ion oscillations as they travel down the drift dimension. This is corrected with a stripe electrode 19 (to act as a compensation electrode) that alters the flight potential for a portion of the inter-mirror space, varying down the length of the opposing mirrors 16, 162. The combination of the varying width of the stripe electrode 19 and variation of the distance between the mirrors 16, 162 allows the reflection and spatial focusing of ions onto the detector 18 as well as maintaining a good time focus. A suitable MR-ToF 15 for use in the present invention is further described in US 2015/0028197 (A1), which is herein incorporated by reference.

In one example, an MS1 scan may be performed by the second mass analyser (e.g., the orbital trapping mass analyser 11). In a second example, precursor ions may be fragmented and MS2 scans may be performed by the second mass analyser (the orbital trapping mass analyser 11) or the first mass analyser (the time-of-flight mass analyser), depending on whether the fragmentation chamber is controlled to eject the ions back towards the C-trap 10 or forwards to the second transfer multipole 13. In a further mode of operation, the second mass analyser (time-of-flight mass analyser 15) may perform MS1 scans of ions. In this mode of operation, the ions are directed axially through the C-trap 10 to the fragmentation chamber, but no fragmentation gases are input and the ions are guided to the second transfer multipole 13 without fragmentation. The ions can then be accumulated into packets in the extraction trap 14, as described above.

Ions accumulated in the extraction trap are injected into the MR-ToF analyser 15 as a packet of ions, once a predetermined number of ions have been accumulated in the extraction trap. By ensuring that each packet of ions injected into the MR-ToF 15 has at least a predetermined (minimum) number of ions, the resulting packet of ions arriving at the detector will be representative of the entire mass range of interest of the MS1 or MS2 spectrum. A single packet of precursor ions or fragmented ions is sufficient to acquire MS1 or MS2 spectra of the respective ions. For MS2, this represents an increased sensitivity compared to conventional acquisition of time-of-flight spectra in which multiple spectra typically are acquired and summed for each given mass range segment. Preferably, a minimum total ion current (TIC) in each mass window is accumulated in the extraction trap before ejection to the time-of-flight mass analyser. In some examples, at least N spectra (scans) are acquired per second in the MS2 domain by the time-of-flight mass analyser, wherein N=50, or more preferably 100, or 200, or more.

Preferably, at least X % of the MS2 scans contain more than Y ion counts (wherein X=30, or 50, or 70, or most preferably 90, or more, and Y=200, or 500, or 1000, or 2000, or 3000, or 5000, or more). Most preferably, at least 90% of the MS2 scans contain more than 500 ion counts, or more preferably more than 1000 ion counts, and ideally more than 5000 ion counts. This provides for an increased dynamic range of MS2 spectra. The desired ion counts for each of the MS2 scans may be provided by adjusting the number ions included in each packet of fragmented ions. For example, in the embodiment of FIG. 1, the accumulation time of the extraction trap may be adjusted to ensure that a sufficient number of ions have been accumulated. As such, the controller may be configured to determine that a suitable packet of fragmented ions has been formed when either a predetermined number of ions are present in the extraction trap, or a predetermined period of time has passed. The predetermined period of time may be specified in order to ensure that the time-of-flight mass analyser operates at the desired frequency when the flow of ions to the extraction trap is relatively low.

The mass spectrometer 1 is under the control of a controller which, for example, is configured to control the timing of ejection of the trapping components, to set the appropriate potentials on the electrodes of the quadrupole etc so as to focus and filter the ions, to capture the mass spectral data from the orbital trapping device 11, to capture the mass spectral data from the MR-ToF 15, control the sequence of MS1 and MS2 scans and so forth. It will be appreciated that the controller may comprise a computer that may be operated according to a computer program comprising instructions to cause the mass spectrometer to execute the steps of the method according to the present invention.

It is to be understood that the specific arrangement of components shown in FIG. 1 is not essential to the methods subsequently described. Indeed other arrangements for carrying out the methods of embodiments of the present invention are suitable. In some examples, all scans (MS1, MS2 and/or SIM) are performed by the MR-ToF analyser, which is faster than the orbital trapping analyser.

A front-end accumulation device, such as an ion mobility separator (e.g., a Trapped Ion Mobility Separator, TIMS), may be configured to release ions in an m/z range corresponding to the quadrupole isolation window. A result of this is to improve ion transmission of the quadrupole filter. As a further result of the ion mobility separator, the required injection time may be reduced (due to the isolated ion beam being brighter). This reduction in injection time may be used to at least partially offset the additional time overhead of the SIM injections.

An ion mobility separator may comprise a stacked ring ion guide, which applies a DC gradient push ions in one direction, opposed by a gas wind in the opposing direction.

In one example of an ion mobility separator, an electric field barrier in a gas flow is used to hold back ions according to their ion mobility. A decrease of the field barrier releases ions with increasing ion mobility.

The TIMS is described in detail in documents U.S. Pat. Nos. 7,838,826, 9,891,194 and Meier et al., 2018, Molecular & Cellular Proteomics 17, 2534-2545, which are herein incorporated by reference.

An extended ion funnel is comprised of a multitude of segmented electrodes, which are assembled about a common axis. The extended ion guide can be treated as three sections:
an entrance focusing section,
a mobility analysis section, and
an exit focusing section.

In the focusing sections, the distances between adjacent electrodes is approximately equal to the thickness of the electrodes. The diameter of the apertures in the electrodes is a function of the position of the electrode in the ion funnel assembly. For example, the segmented electrode having the largest aperture is at entrance end of the ion funnel and the segmented electrode having the smallest aperture is at the exit end of the ion funnel.

In some examples, the aperture diameter may be a linear function of the segmented electrode's position. In other examples, this function may be non-linear. The angle formed between common axis and the inner boundary (i.e., formed by the inner rims of the segmented electrodes) of the ion funnel may be approximately 19°. However, any angle between 0° and 90° may be used.

In the mobility analysis section of the ion funnel, the segmented electrodes may all have the same inner diameter. The space between adjacent electrodes may be filled with dielectric or electrically resistive gaskets. The thickness of the segmented electrodes should be smaller than its inner diameter and the spacing between the electrodes should be smaller than the thickness of the segmented electrodes to maintain a uniform RF field, so that the axial DC field is homogeneous near the axis.

Gaskets or o-rings between the electrodes form a substantially air-tight seal so that the apertures in the electrodes form a gas tight channel through which gas may flow. Gas enters the channel in the entrance focussing section, forms a laminar stream that flows uniformly through the mobility analysis section, is constricted through the exit focusing section and then flows out through the aperture in the final electrode. The apertures are substantially cylindrically symmetric to maintain a cylindrically symmetric flow profile. In operation, a symmetric laminar flow of gas means that all ions of a given type at a given position along the axis will experience a given force due to the gas flow, substantially independent of their lateral position with respect to the axis.

A quadrupole ion filter consists of four rods equally spaced at a predetermined radius around a central axis. A radio frequency, RF, (e.g. a 1 MHz sine wave) potential is applied between the rods. The potential on adjacent rods is 180° out of phase. Rods on opposite sides of the axis of quadrupole are electrically connected, so that the quadrupole is formed as two pairs of rods. Ions travel along the axis of quadrupole and exit the quadrupole through an aperture. The RF potential applied between the rods tends to confine the ions radially. When only RF is applied between the rods, substantially all ions are transmitted through the quadrupole. Applying a DC as well as an RF potential between the pairs of rods causes ions of only a limited mass range to be transmitted through quadrupole. Ions outside this mass range are filtered away and do not reach the exit end.

The DC electric field strength varies as a function of position along the axis. However, at some position in analysis section, the field strength reaches a maximum so as to form a barrier which ions must overcome in order to reach the exit end of the funnel. Near this position of maximum field strength, the uniformity of the DC field is important because this is the point at which ions are selected on the basis of their mobility. The DC field should therefore be cylindrically symmetric.

An example method of operation comprises the steps of:
forming a DC barrier in the analysis section;
applying an RF field for focusing ions towards the axis;
generating ions in an ion source;
introducing ions in a carrier gas into the extended ion funnel;
introducing ions into the focusing section by applying potentials to the electrodes of the focusing section and/or the deflection electrode;
transferring ions into the analysis section by applying DC potentials to the electrodes of the focusing section;
optionally preventing additional ions from entering the analysis section by applying DC potentials to the deflection electrode and/or the electrodes of the focusing section;
inducing a carrier gas flow through the channel using a pump downstream from the exit end of the funnel;
gradually reducing the DC barrier in the analysis section to allow the carrier gas flow to push ions from the group of ions over the DC barrier in order of the ions' mobilities; and
focusing ions through the aperture in the exit electrode.

In another example, a DC gradient is used to push ions out, opposed by a gas wind. As the DC potential is increased, ions are released in order of mobility.

In one example method, a full mass scan is performed by the Fourier transform mass analyser 11 with a long acquisition transient, generating high-resolution MS1 spectra. In parallel to this, the MR-ToF 15 analyser performs a series of MS2 acquisitions with very fast scanning speed and high sensitivity.

An example method for combined ion injection and analysis is described in U.S. Pat. No. 8,686,350, which is herein incorporated by reference.

An example method described herein accumulates different types of ions for separate analysis: first, precursor ions that have not been fragmented; and second fragment ions that are formed from fragmentation of the precursor ions. The ions may come from the same ion source and with the same quadrupole isolation window but with different fragmentation energies (a collision energy of zero for the precursor ions). The fragment ions are analysed in a mass analyser to provide fragment spectra. The precursor ions are accumulated in an ion store and combined with precursor ions from other quadrupole isolation windows. The combined precursor ions are then analysed in a mass analyser to provide analytical scan data. Such scan data provides precursor information, in addition to the fragment spectra. The precursor ion accumulation may be performed quickly alongside the usual MS2 fragment analysis, as there is no additional quadrupole switching time, and the additional inject time for the precursor ion (SIM) component should be lower than for the fragmentation injection.

Where analysis is to be performed using a hybrid instrument, such as the one illustrated in FIG. 1, it is preferable that the SIM components (the unfragmented precursor ions for each sub-range) are measured in a high resolution MS1 scan. To perform this, it is necessary to separate the unfragmented SIM component from the fragmented MS2 component and then collect them for separate analysis.

In some examples, ions may be split between two separate ion destinations via the use of a beam switching device to create a branched ion path. A switchable-path ion guide is described in UK Patent Application Number 2209555.8, which is herein incorporated by reference. Other suitable devices are described in patent publications U.S. Pat. No. 7,829,850B2, US 2019/0103261A1, U.S. Pat. Nos. 8,581,181B2 and 9,984,861B2. As described above, in such a DIA method, for every injection that is performed with fragmentation, there is an additional injection with the same quadrupole isolation window and no fragmentation energy. The target mass is scanned through a predetermined range and isolation step size as is normal for DIA.

To further improve efficiency, it would be preferable to eliminate the overhead resulting from needing to actively switch beam paths. One way to perform this is to separate out a portion of an ion injection. This may be achieved by discriminating on a property of the ions, such as position or energy. Then, a single (longer) injection could be separated and used to supply two ion destinations. Even more preferably, the conditions are set so that a proportion of the ion beam is separated, either as a function of collisional cooling or spatial distribution, and the split ion beam is delivered to separate ion destinations. This then saves further on time overhead between injections.

A method of beam splitting via skimming off cooled ions at a potential barrier is therefore provided.

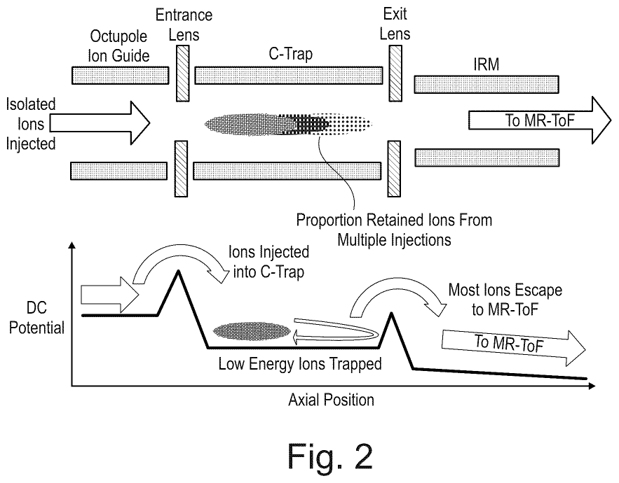

FIG. 2 illustrates an ion beam clipping method according to the present disclosure. Ion beam clipping is performed within an ion store (such as a C-Trap) based upon discrimination by ion energy. Ions are injected through an entrance aperture (or lens). At the exit aperture (or lens), most of the injected ions are ejected. However, low-energy ions will be unable to pass the potential barrier and are trapped within the ion store.

An example method for clipping the ion beam makes use of an ion beam's energy distribution. When an ion beam is passed over a relatively high DC potential barrier, for example at a decelerating lens or segment of an ion guide, it is possible for a proportion of ions with low kinetic energy to be reflected by the barrier. FIG. 2 demonstrates a method whereby the ion beam is passed from an ion guide, through the C-Trap, on its way to the IRM for fragmentation. The fragmented ions are then sent for MS2 analysis in the MR-ToF analyser. Both the entrance lens and the exit lens are set to higher potentials that the C-Trap body, and there is the usual DC drop between ion optical devices to keep ions moving. The exit lens is set to a sufficient potential (around +5V) that some proportion of the ions, preferably around 5-20%, are blocked from exiting and become trapped in the C-Trap. This is helped by the fact that ions passing through the C-Trap may lose energy via collisions with the C-Trap's buffer gas. The buffer gas in the C-Trap may be nitrogen at a pressure of approximately 2×10⁻³ mbar in some examples. This may correspond to a preferable “collisional thickness” of 0.05 mbar*mm of nitrogen, which is significantly lower than the typical requirement for collisional cooling (typically, collisional cooling is performed at a collisional thickness of around 0.2 mbar*mm, as described in U.S. Pat. No. 4,963,736). Preferably, “collisional thickness” lies in the range 0.02-0.10 mbar*mm of nitrogen for small molecules and peptides and is scaled appropriately with collisional cross-section for other types of molecules (e.g., proteins and protein complexes).

In a DIA method, most of the ions will be sent for analysis as a series of MS2 scans, whilst a proportion will be retained and accumulated in the ion guide. Over the course of multiple MS2 scans, a large build-up of ions will be present in the C-Trap, and may be ejected into the Fourier transform mass analyser to provide a HDR scan, in a similar manner to the “Boxcar” method described in the background. Advantageously this method may be performed on the instrument of FIG. 1, without significant modification.

The method described with respect to FIG. 2 may be performed using the C-Trap 100 within the hybrid mass spectrometer of FIG. 1. A DIA method using the hybrid mass spectrometer of FIG. 1 will now be described by way of a specific example. The C-Trap lenses are set so that some proportion of the ion beam traversing the C-Trap is clipped off by the exit lens and retained within the C-Trap. Ions having m/z values within a series of sub-ranges are injected sequentially into the C-Trap. An inject time for each sub-range is proportional to the local ion intensity within that sub-range (to hit an overall target ion number for the sub-range). In this way, highly prevalent species will be attenuated, preventing them from dominating the overall population in a manner similar to the Boxcar/HDR method. At the end of each DIA cycle, the built up population of precursor ions retained by the C-Trap may be pulsed out into the second mass analyser (e.g., Fourier transform mass analyser) for a high resolution full-MS analysis.

One challenge faced with this method is brought about by the method's mass/charge dependent character, and space charge response. The energy distribution of the ion beam at the exit lens may be mass and mobility dependent, as ions are collisionally cooled to different proportions based on these properties. To account for these effects within each sub-range, it is preferable that the injected ions are quite narrowly mass filtered. Moreover, charge state of the injected ions may be determined and compensated for. Calibration of the device parameters between sub-ranges may be performed to account for these effects. In one example ion energy (via the DC path) may be adjusted based on the m/z values of the ions within the sub-range. In another example, the exit lens DC potential barrier may be adjusted between each sub-range. For example, it may be necessary to raise the exit lens DC potential barrier for injected ions having higher m/z values.

After a large number of ions have been accumulated within the C-Trap, strong space charge conditions within the trap may raise the local potential, redistribute incident ion energy, and push out already trapped ions axially and radially. It may be possible to compensate for these effects via tuning of device parameters (e.g., levels of DC potential barriers, internal trap potential, ion cooling, ion injection energy and the like).

Another method to compensate for space charge effects is to store the retained ions in another type of storage device where there is a weak potential saddle along the principal axis of the device. This may allow slow ions (with lower energies) to “roll away” from the principal axis along which fast ions are flying.

In another example, ions may be stored along the principal axis but away from the potential barrier at the outlet region. In this case, a long system may be provided.

In another example, ions may be stored under a small intermediate barrier, such as that created by auxiliary trapping electrodes, whilst a second stronger barrier is created at the outlet region. Then, space charge of the retained ions will build up on the periphery of the storage device, reducing the effect on fly-through of other ions. Given that pressure control is relatively slow, ion capture may be controlled by setting the levels of the intermediate potential barriers and the potential barrier at the outlet aperture.

In an example experiment, Pierce Flexmix calibration solution was infused into a Fourier transform/MR-ToF hybrid mass spectrometer of the class described in relation to FIG. 1. A DIA method was run in which the instrument cycled through a series of MR-ToF MS2 mass analysis operations for sub-ranges within the overall m/z range of 350-980 Th. Additionally a single full MS scan of m/z range 150-2000 was performed using a Fourier transform mass analyser for each DIA cycle. During this DIA method, the C-Trap entrance lens was overridden to +5V, to allow transmission of the ˜6 eV ion beam, but retention of captured ions. The DC potential at the barrier at the outlet region (exit lens) of the C-Trap was increased from 0 V to 2V to 4V to 6V to 8V and the DIA cycle was repeated for each potential.

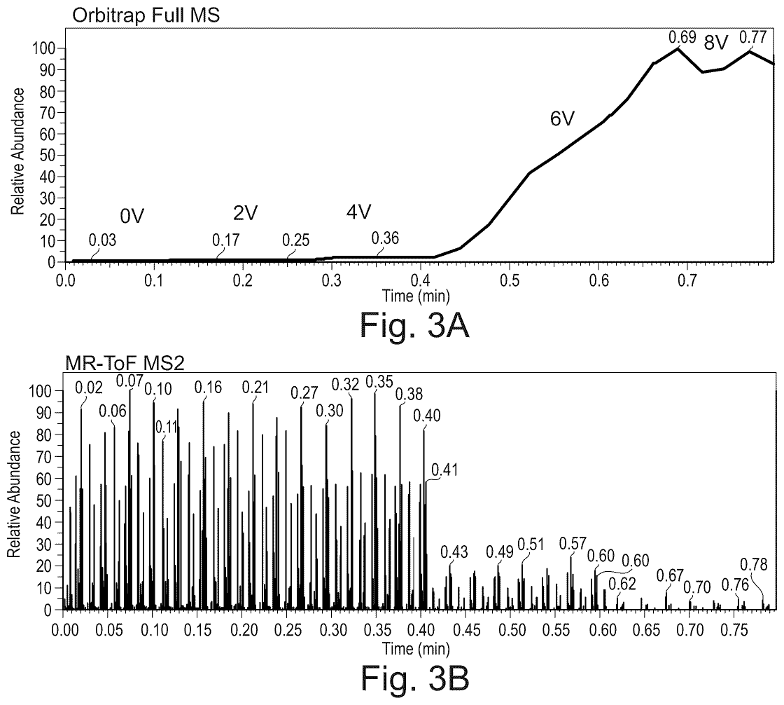

FIG. 3 shows the relative intensities of mass spectra in the Fourier transform mass analyser and the MR-ToF mass analyser as the DC potential at the barrier at the outlet region was increased.

FIG. 3A illustrates signal intensity in a Fourier transform mass analyser performing full-MS scans on ions retained across a plurality of sub-ranges against time, as a potential barrier at the outlet aperture of a C-Trap (the “exit lens potential”) is increased over time.

FIG. 3B illustrates signal intensity in a time-of-flight mass analyser performing MS2 fragment scans for each of the plurality of sub-ranges against time, as a potential barrier at the outlet aperture of a C-Trap (the “exit lens potential”) is increased over time.

It can be seen that the MR-ToF signal was not greatly affected until the step to 6V, which correlates to the 6 eV injection energy into the C-Trap. Nevertheless, some ions still get through even at 8V, though only a small proportion. This is to be expected, because the true potential barrier is determined not only by the DC potential applied to the outlet barrier but also by the lower potentials of the surrounding ion optical elements. The Fourier transform mass analyser signal increases significantly at the 6V point, implying that captured ions from the DIA cycle are being injected into the Fourier transform mass analyser for a full MS scan, as intended.

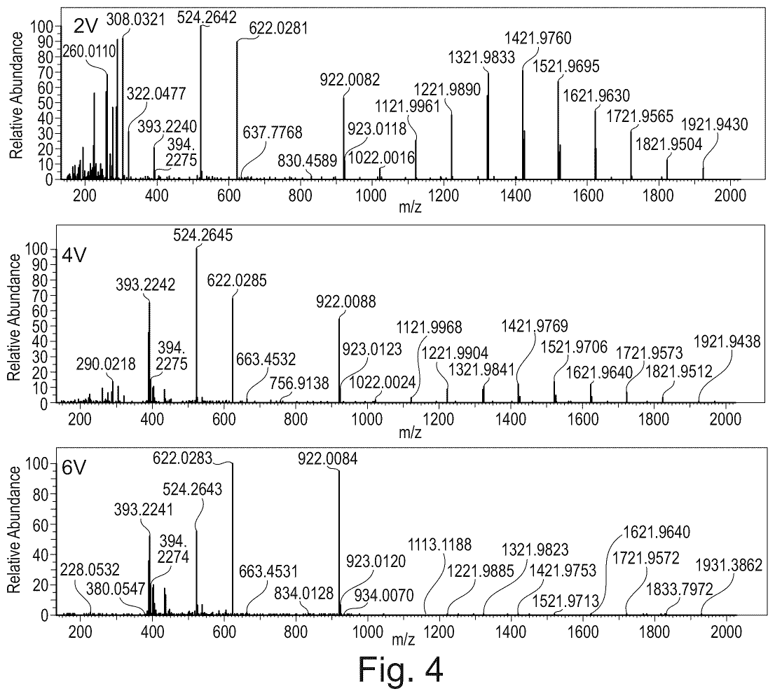

FIG. 4 shows full MS mass spectra acquired on the Fourier transform mass analyser during the times the C-Trap exit lens was held at 2V, 4V and 6V. At 2V, the 150-2000 full MS scan resembles the Flexmix distribution. There is an anomalous attenuation of the doubly charged MRFA peptide at m/z 262, though this is most likely a result of flawed timings in the prototype software build and may be disregarded.

At 4eV, the ions within the DIA cycle range of 350-980 become more prominent, whilst the higher m/z ultramark envelope are relatively diminished. By the 6V spectrum, ultramark was greatly proportionally diminished and the spectrum completely dominated by ions captured from the DIA cycle. Note also the higher relative proportion of the lesser peaks within the DIA m/z range, implying an improvement in dynamic range, even within this basic experiment.

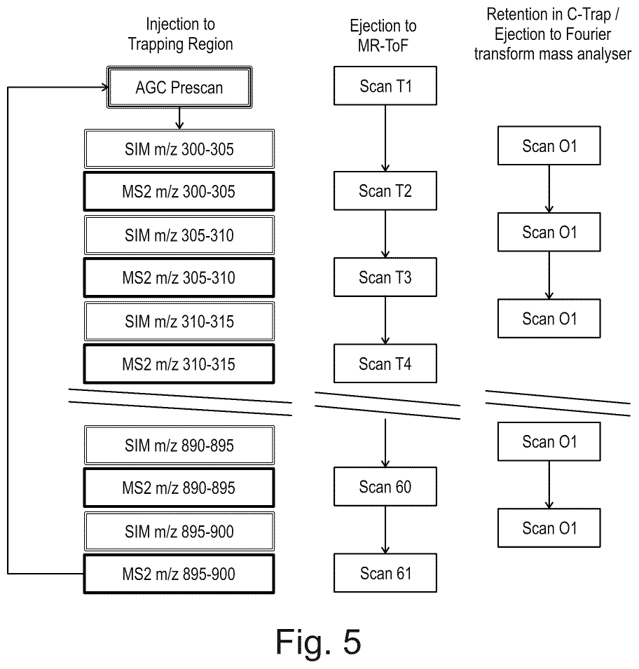

FIG. 5 shows a graphical explanation of a DIA method that might be implemented on the mass spectrometer of FIG. 1. In a DIA method according to some specific examples, for every injection that is performed with fragmentation into the second ion store, precursor ions are retained within the first ion store with the same quadrupole isolation window (reduced or no collision energy since these are precursor ions). The target mass is scanned through a predetermined range and isolation step size as is normal for DIA. FIG. 5 shows such a scan sequence from m/z 300-900 Th, with 5 Th isolation windows, as may be used for “bottom-up” measurement of digested protein samples. An optional AGC (automatic gain control) pre-scan may be performed (preferably in the time-of-flight mass analyser) to help determine suitable ion injection times in subsequent scans. Alternatively, an optional MS1 full scan may be performed using the Fourier transform mass analyser (e.g., Orbitrap™ mass analyser). The MS2 injections are passed to the linear trap and extracted to the time-of-flight (e.g., MR-ToF) mass analyser for a series of scans (T1 to T61). The SIM injections are accumulated together in an ion store, such as a curved linear ion store (C-Trap) or other ion trapping device. An HDR MSI scan can be generated by analysing the combined precursor ions (e.g., in the Fourier transform mass analyser).

The SIM and MS2 injections are performed concurrently to minimise the quadrupole and source switching time overhead, which might otherwise greatly reduce the time available for ion accumulation. At the end of the cycle, the accumulated series of SIM injections are then extracted to the Fourier transform mass analyser for a long transient analysis, for example at 240K resolution.

It is advantageous that AGC is used to control the number of ions in the curved linear ion store and Fourier transform mass analyser, so that the number of precursor ions retained in the first ion store for each SIM injection does not add up to a level that overwhelms the ion store once all the injections have been performed. For example, if there are 60 SIM injections per cycle, then one might limit the number of ions retained in the first ion store from each SIM injection to ˜1500 ions.

For longer cycles, an additional scan using the Fourier transform mass analyser may be performed in the middle of the cycle, to increase the dynamic range of the precursor scan data, at the cost of reducing maximum transient time by half. In other words, precursor ions retained in the first ion store from SIM injections from the first half of the plurality of sub-ranges may be analysed together in a first scan and precursor ions retained in the first ion store from SIM injections from the second half of the plurality of sub-ranges may be analysed together in a second scan.

More generally, rather than performing one scan for precursor ions from the overall m/z range, the method may comprise a plurality of scans of precursor ions, where each scan comprises precursor ions from a plurality of sub-ranges.

The method of FIG. 5 could be performed on the combined Fourier transform mass analyser and MR-ToF instrument illustrated in FIG. 1. Alternatively, the method could be performed on a single mass analyser instrument, such as a ToF-only instrument or a Fourier transform mass analyser-only instrument (and may take longer).

The timings of the different operations may be configured so that certain operations are performed in parallel, to reduce the overall time taken. The Fourier transform/MR-ToF instrument illustrated in FIG. 1 may be capable of running single injections at approximately 200 Hz with a 3 ms inject time (also referred to as “fill time”) and 2 ms overhead. Additional overhead would deplete the duty cycle and reduce instrument sensitivity.

The ions are transported from the ion source through to the analyser. Multiple separate ion packets may be processed simultaneously in the different components.

Fragmentation may be carried out in the IRM 120 or the high-pressure region of the second ion store (also referred to as the “extraction trap” 140). During operation according to some example methods, the collision energy of the fragmentation chamber may be adjusted.

Because the first ion store is retaining precursor ions for the first ion destination (e.g., Fourier transform mass analyser) and transporting precursor ions to the second ion destination (e.g., second ion store or ToF mass analyser), fragmentation is performed downstream of the first ion store (e.g., by the high-pressure region of the extraction trap 140 or the IRM collision cell 120.

In a further variation of the DIA process illustrated in FIG. 3, stepped fragmentation energies may be applied for each MS2 scan. In other words, the MS2 ions are added to the second ion store in multiple injections, each injection having a different fragmentation energy.

In some variations of the methods, where a pre-scan is performed, it may be preferable not to perform SIM injections for m/z sub-ranges of the overall precursor mass range that are already heavily populated. This may be determined from the full-MS pre-scan, which should be able to gather sufficient data for such regions. Omitting

SIM injections for these sub-ranges may further reduce the time required for the overall method and improve the resolution of the scan(s) for the combined SIM injections. SIM injections may be omitted by operating the ion beam splitter in a mode of operation such that substantially all of the packet of ions is directed to the second outlet region. A HDR MS1 scan can be obtained by combining the full-MS pre-scan with the scan for the combined SIM injections.

The use of a front-end accumulation device such as a Trapped Ion Mobility Separator (as incorporated into the Bruker TIMS-ToF series of mass spectrometers), or Structures for Lossless Ion Manipulations (SLIM) may also be advantageous to the examples described above. Such a device may release ions in an m/z range synchronised to the quadrupole isolation window. As a result, ion transmission may be improved. As a further result, the required injection time may be reduced (due to brighter isolated ion beam). This reduction in injection time may be used to offset the additional time overhead of the SIM injections.

The above examples are described in the context of a C-Trap and instruments comprising a C-Trap, which are particularly suitable for performing the disclosed methods. However, these methods could be performed using any instrument with a suitable collisional thickness and arranged to generate a controlled potential barrier. Many different other types of ion store are suitable. Moreover, a multipole device (such as an IRM) may also be suitable for performing the proposed methods. The usual operational conditions of a multiple device are 1×10⁻² mbar over 120 mm length. To facilitate proportional cooling of the ion beam for implementation of the proposed methods, the usual multipole conditions may be scaled down by about two to three times.

Herein the term mass may be used to refer to the mass-to-charge ratio, m/z. The resolution of a mass analyser is to be understood to refer to the resolution of the mass analyser as determined at a mass to charge ratio of 200 unless otherwise stated.

In the description of the invention herein, it is understood that a word appearing in the singular encompasses its plural counterpart, and a word appearing in the plural encompasses its singular counterpart, unless implicitly or explicitly understood or stated otherwise. Furthermore, it is understood that, for any given component or embodiment described herein, any of the possible candidates or alternatives listed for that component may generally be used individually or in combination with one another, unless implicitly or explicitly understood or stated otherwise. Moreover, it is to be appreciated that the figures, as shown herein, are not necessarily drawn to scale, wherein some of the elements may be drawn merely for clarity of the invention. Also, reference numerals may be repeated among the various figures to show corresponding or analogous elements. Additionally, it will be understood that any list of such candidates or alternatives is merely illustrative, not limiting, unless implicitly or explicitly understood or stated otherwise.

Unless otherwise defined, all other technical and scientific terms used herein have the meaning commonly understood by one of ordinary skill in the art to which this invention belongs. In case of conflict, the present specification, including definitions, will control. It will be appreciated that there is an implied “about” prior to the quantitative terms mentioned in the present description, such that slight and insubstantial deviations are within the scope of the present teachings. In this application, the use of the singular includes the plural unless specifically stated otherwise. Also, the use of “comprise”, “comprises”, “comprising”, “contain”, “contains”, “containing”, “include”, “includes”, and “including” are not intended to be limiting and do not exclude the possibility that other elements are also included. Where the word “consisting” is used, this is intended to indicate that other elements are excluded. As used herein, “a” or “an” also may refer to “at least one” or “one or more.” Also, the use of “or” is inclusive, such that the phrase “A or B” is true when “A” is true, “B” is true, or both “A” and “B” are true.

As used in this document, the term “scan”, when used as a noun, means a mass spectrum, regardless of the type of mass analyzer used to generate and acquire the mass spectrum. When used as a verb herein, the term “scan” refers to the generation and acquisition of a mass spectrum by a method of mass analysis, regardless of the type of mass analyzer or mass analysis used to generate and acquire the mass spectrum. As used herein, the term “full scan” refers to a mass spectrum than encompasses a range of mass-to-charge (m/z) values that includes a plurality of mass spectral peaks.

As used in this document, each of the terms “liquid chromatograph” and “liquid chromatography” (both abbreviated “LC”) as well as the term “Liquid Chromatography Mass Spectrometry” (abbreviated as “LC-MS”) are intended to apply to any type of liquid separation system that is capable of separating a multi-analyte-bearing liquid sample into various “fractions” or “separates”, where the chemical composition of each such “fraction” or “separate” is different from the chemical composition of every other such fraction or separate, wherein the term “chemical composition” refers to the numbers, concentrations, and/or identities of the various analytes in a fraction or separate. As such, the terms “liquid chromatograph”, “liquid chromatography” “Liquid Chromatography Mass Spectrometry”, “LC”, and “LC-MS” are intended to include and to refer to, without limitation, liquid chromatographs, high-performance liquid chromatographs, ultra-high-performance liquid chromatographs, size-exclusion chromatographs and capillary electrophoresis devices.

Instead of the LC device any other separation device, including an ion mobility device, HPLC, GC or ion chromatography could be interfaced to the mass spectrometer. Also any known fragmentation method (including collisionally activated dissociation, photon induced dissociation, electron capture or electron transfer dissociation) produces data suitable for use with the invention.

Although embodiments according to the disclosure have been described with reference to particular types of devices and applications (particularly mass spectrometers) and the embodiments have particular advantages in such case, as discussed herein, approaches according to the disclosure may be applied to other types of device and/or application. The specific manufacturing details of the ion guide and associated uses, whilst potentially advantageous (especially in view of known manufacturing constraints and capabilities), may be varied significantly to arrive at devices with similar or identical operation. Each feature disclosed in this specification, unless stated otherwise, may be replaced by alternative features serving the same, equivalent or similar purpose. Thus, unless stated otherwise, each feature disclosed is one example only of a generic series of equivalent or similar features.

The use of any and all examples, or exemplary language (“for instance”, “such as”, “for example” and like language) provided herein, is intended merely to better illustrate the invention and does not indicate a limitation on the scope of the invention unless otherwise claimed. No language in the specification should be construed as indicating any non-claimed element as essential to the practice of the invention.

Any steps described in this specification may be performed in any order or simultaneously unless stated or the context requires otherwise.

All of the aspects and/or features disclosed in this specification may be combined in any combination, except combinations where at least some of such features and/or steps are mutually exclusive. As described herein, there may be particular combinations of aspects that are of further benefit, such the aspects of ion guides for use in mass spectrometers and/or ion mobility spectrometers. In particular, the preferred features of the invention are applicable to all aspects of the invention and may be used in any combination. Likewise, features described in non-essential combinations may be used separately (not in combination).

We claim:

1. A method of mass spectrometry comprising the steps of:
for each of a plurality of sub-ranges selected from an overall m/z range:
injecting a sample of precursor ions into a first ion store via an entrance region, the precursor ions having m/z values within the sub-range;
retaining a first portion of the sample of precursor ions within the first ion store, wherein the first portion comprises ions having m/z values within the sub-range;
ejecting a second portion of the sample of precursor ions from the first ion store via an outlet region, wherein the second portion comprises ions having m/z values within the sub-range; and
either:
a) analysing a sample of fragmented precursor ions in a first mass analyser, or
b) accumulating a sample of fragmented precursor ions in a second ion store for analysis in a first mass analyser,
wherein the sample of fragmented precursor ions are formed from fragmentation of the second portion of precursor ions.

2. The method of claim 1, wherein each of the plurality of sub-ranges has a same width, wherein the width of each sub-range is 20 Thomson or less.

3. The method of claim 1, wherein a DC potential barrier is provided at the outlet region.

4. The method of claim 3, further comprising, for each sub-range:
determining a charge state of the sample of precursor ions and adjusting the DC potential barrier, based on the charge state of the sample of precursor ions; and/.or
adjusting the DC potential barrier, based on the m/z sub-range; and/or
adjusting the DC potential barrier to compensate for space charge conditions.

5. The method of claim 3, wherein the first ion store comprises one or more intermediate potential barriers, wherein the first portion of the sample of precursor ions are retained under the one or more intermediate potential barriers, wherein the one or more intermediate potential barriers are relatively small compared to the DC potential barrier at the outlet region.

6. The method of claim 1, further comprising, for each sub-range:
adjusting an ion energy of the sample of precursor ions and/or adjusting a DC potential barrier at an exit aperture to compensate for space charge conditions; and/or
adjusting an ion energy of the sample of precursor ions, based on the m/z sub-range.

7. The method of claim 1, wherein:
retaining the first portion of the sample of precursor ions within the first ion store comprises retaining the first portion of the sample of precursor ions away from a principal axis of the first ion store, so that the sample of precursor ions for an immediately subsequent sub-range are not blocked; and/or
the first ion store comprises a weak potential saddle, so that the first portion of the sample of precursor ions are stored away from a principal axis of the first ion store; and/or
the first ion store has a length, wherein the length of the first ion store is sufficient that a majority the first portion of the sample of precursor ions are retained in the first ion store away from the outlet region.

8. The method of claim 1, wherein the method further comprises transferring precursor ions retained in the first ion store to a) the first mass analyser or b) the second ion store, wherein the precursor ions transferred from the first ion store comprise the first portions of the samples of precursor ions for each of the plurality of sub-ranges.

9. The method of claim 1, wherein the first ion store is configured to operate under pure molecular flow conditions.

10. The method of claim 1, further comprising, for each of the plurality of sub-ranges, configuring an ion filter to transmit precursor ions having m/z values within the sub-range, wherein the sample of precursor ions is received from the configured ion filter and the sample of fragmented precursor ions is formed from fragmentation of precursor ions received from the configured ion filter.

11. The method of claim 10, wherein configuring the ion filter comprises setting a transmission window of the ion filter, wherein the transmission window is adjusted between each of the plurality of sub-ranges, wherein for each sub-range, the transmission window for the step of injecting the sample of precursor ions is the same as the transmission window for the step of a) analysing the sample of fragmented precursor ions or b) accumulating the sample of fragmented precursor ions.

12. The method of claim 10, further comprising configuring an ion mobility separator to transfer precursor ions having m/z values within the sub-range to the ion filter.

13. The method of claim 12, further comprising controlling the ion mobility separator so that the precursor ions transferred to the ion filter correspond with a transmission window of the ion filter, for each of the plurality of sub-ranges in the overall m/z range.

14. The method of claim 1, wherein injecting the sample of precursor ions comprises controlling a fill time for the precursor ions, based on a relative abundance of precursor ion species in the corresponding sub-range.

15. The method of claim 1, further comprising:
configuring an ion filter to transmit precursor ions having m/z values from the overall m/z range;
transferring an initial sample of precursor ions having m/z values from the overall m/z range to the first mass analyser or a second mass analyser;
analysing the initial sample of precursor ions; and
obtaining scan data for the overall m/z range from analysis of the initial sample of precursor ions.

16. The method of claim 15, further comprising:
for each sub-range, adjusting an injection time of the sample of precursor ions based on the scan data obtained from analysis of the initial sample of precursor ions.

17. A method of manipulating ions using an ion store comprising:
an inlet region, an outlet region; and a trapping volume between the inlet region and the outlet region, the method comprising:
injecting a packet of ions via the inlet region, wherein the packet of ions comprises ions having m/z values within a sub-range selected from an overall m/z range;
applying a DC potential barrier at the inlet region and the outlet region;
retaining a first portion of the packet of ions within the trapping volume, wherein the first portion comprises ions having m/z values within the sub-range; and
ejecting a second portion of the packet of ions via the outlet region, wherein the second portion comprises ions having m/z values within the sub-range.

18. The method of claim 17, wherein:
the DC potential barrier applied at the outlet region is greater than a DC potential in the trapping volume; and/or the DC potential barrier applied at an inlet aperture is greater than a DC potential in the trapping volume.

19. The method of claim 17, wherein a width of the sub-range is 20 Thomson or less.

20. The method of claim 17, further comprising one or more of:
determining a charge state of the packet of ions and adjusting the DC potential barrier at the outlet region based on the determined charge state of the packet of ions;
adjusting an ion energy of the packet of ions, based on a m/z range of the packet of ions;
adjusting a DC potential barrier at an outlet aperture, based on a m/z range of the packet of ions; and
adjusting an ion energy of the packet of ions and/or adjusting a DC potential barrier at the outlet aperture to compensate for space charge conditions.

21. The method of claim 17, wherein:
retaining the first portion of the packet of ions within the ion store comprises retaining the first portion of the packet of ions away from a principal axis of the ion store; and/or
the ion store comprises a weak potential saddle, so that the first portion of the packet of ions are stored away from a principal axis of the ion store; and/or the ion store has a length sufficient that a majority the first portion of the packet of ions are retained in the ion store away from the outlet region.

22. The method of claim 17, wherein the ion store comprises one or more intermediate potential barriers, wherein the first portion of the packet of ions are retained under the one or more intermediate potential barriers, wherein the one or more intermediate potential barriers are relatively small compared to the DC potential barrier at the outlet region.

23. A mass spectrometer configured to perform the method of claim 1.

24. An ion store configured to perform the method of claim 17.

25. One or more computer-readable media having stored thereon processor-executable instructions for a method as recited in claim 1.
